(19) United States
(12) Patent Application Publication
(10) Pub. No.: US 2025/0063002 A1
(43) Pub. Date: Feb. 20, 2025

(54) COMMUNICATION SYSTEM, COMMUNICATION APPARATUS, COMMUNICATION METHOD, AND NON-TRANSITORY COMPUTER-READABLE MEDIUM STORING COMMUNICATION PROGRAM

(71) Applicant: NEC Corporation, Minato-ku, Tokyo (JP)

(72) Inventor: Shinichi ANAMI, Tokyo (JP)

(73) Assignee: NEC Corporation, Minato-ku, Tokyo (JP)

(21) Appl. No.: 18/724,215

(22) PCT Filed: Mar. 3, 2023
(86) PCT No.: PCT/JP2023/008080

§ 371 Date: Jun. 26, 2024

(30) Foreign Application Priority Data
Mar. 9, 2022 (JP) 2022-035833

(51) Int. Cl. H04L 49/201; H04L 12/46

(52) U.S. Cl. CPC H04L 49/201; H04L 12/4633

(57) ABSTRACT

A communication system includes at least one first device having a communication function, at least one second device having a communication function, and a communication apparatus that communicates with the first device within the same network, forms a tunnel network together with the opposite second device and virtually communicates with the second device in the same network segment via the tunnel network, executes IGMP snooping and analyzes a multicast transfer policy, and controls packet transfer according to the multicast transfer policy for a packet to be transferred in communication between the first device and the second device. Accordingly, it is possible to provide a communication system that can maintain communication quality, improve usability, and suppress a failure.

### TECHNICAL FIELD

The present invention relates to a communication system, a communication apparatus, a communication method, and a communication program.

### BACKGROUND ART

A multicast packet is transferred (hereinafter referred to as flooding) to all ports other than a received communication port by a relay device on a network (NW) (hereinafter referred to as a NW switch) in such a way as to reach all devices on the NW in principle due to a characteristic of transmitting data from one transmission source to a plurality of destinations.

In a large-scale NW configured by using a plurality of relay devices, such as an NW in a company, when this multicast is simply flooded, a communication amount increases and a communication bandwidth is compressed, or a packet loops and causes a failure.

In a case where a wireless local area network (LAN) communication section is included in an NW path, when an access point (hereinafter referred to as an AP: access point) that relays a wired LAN and a wireless LAN floods a multicast packet in the same manner, a wireless band may be exhausted by itself, which may have an enormous impact to the extent that data communication being originally desired to be communicated becomes impossible.

Therefore, a content of a packet of a protocol called an internet group management protocol (IGMP) for exchanging participation in and leaving from a multicast group is confirmed, and a transfer path of a multicast packet is adjusted (hereinafter referred to as multicast routing) between relay devices by using a function (IGMP snooping) of controlling a multicast packet to be transferred only to a path in which a receiver is present or a protocol called protocol-independent multicast (PIM), whereby suppressing communication volume and avoiding a failure are performed.

Multicast routing using the PIM is performed between NW switches that straddle internet protocol (IP) segments, and is not performed by a NW switch in the same IP segment, but when the NW includes a wireless LAN section as described above, even when the communication volume is limited in the segment, an adverse effect on the wireless band is large.

Although it is within a segment, it is not only very troublesome to manually prepare a routing table, but it is not possible to deal with a change, an addition, and expansion of a system.

Therefore, in Patent Literature 1, in a device that forms a tunnel across a wireless section, a multicast or broadcast packet is expected to be transferred outside the tunnel, and is not transferred into the tunnel, thereby preventing the wireless section from being transferred in duplicate.

### CITATION LIST

### Patent Literature

Patent Literature 1: Japanese Unexamined Patent Application Publication No. 2018-198384

### SUMMARY OF INVENTION

In some cases, a communication volume of a wireless section can be improved by this method, but there is a possibility that necessary multicast or broadcast may be discarded depending on device setting of the NW and a design of segments inside and outside the tunnel. Further, in a case of a wireless LAN, there is a possibility that multicast is dropped in a wireless section because retransmission control does not work.

A communication system according to one example embodiment includes: at least one first device configured to have a communication function: at least one second device configured to have a communication function; and a communication apparatus configured to communicate with the first device within the same network, form a tunnel network together with the opposite second device and virtually communicate with the second device in the same network segment via the tunnel network, execute IGMP snooping and analyze a multicast transfer policy, and control packet transfer according to the multicast transfer policy for a packet to be transferred in communication between the first device and the second device.

A communication apparatus according to one example embodiment includes: a communication means for communicating with a device within the same network: a tunnel communication means for forming a tunnel network together with an opposite device, and virtually enabling communication with the opposite device in the same network segment via the tunnel network: a policy storage unit configured to store a plurality of communication policies between the same network and the same network segment, and enable reference to the communication policy; and a transfer control means for referring to a communication policy stored in the policy storage unit, and performing transfer control of a packet received in the communication means or the tunnel communication means according to the communication policy.

A communication method according to one example embodiment includes: communicating with at least one first device within the same network: forming a tunnel network together with at least one opposite second device, and virtually communicating with the second device in the same network segment via the tunnel network: executing IGMP snooping, and analyzing a multicast transfer policy; and controlling packet transfer according to the multicast transfer policy for a packet to be transferred in communication between the first device and the second device.

A communication program according to one example embodiment causes a computer to execute: a step of communicating with at least one first device within the same network: a step of forming a tunnel network together with at least one opposite second device, and virtually communicating with the second device in the same network segment via the tunnel network: a step of executing IGMP snooping, and analyzing a multicast transfer policy; and a step of controlling packet transfer according to the multicast transfer policy for a packet to be transferred in communication between the first device and the second device.

According to a communication system, a communication apparatus, a communication method, and a communication program of the present disclosure, it is possible to maintain communication quality, improve usability, and suppress a failure.

### BRIEF DESCRIPTION OF DRAWINGS

FIG. 1 is a block diagram illustrating a configuration of a communication system according to a first example embodiment;

FIG. 2 is a block diagram illustrating a configuration of a communication system according to a second example embodiment:

FIG. 3 is a block diagram illustrating a configuration of a tunnel master device according to the second example embodiment;

FIG. 4 is a block diagram illustrating a configuration of a tunnel slave device according to the second example embodiment:

FIG. 5 is a flowchart illustrating an example of operation of the tunnel master device according to the second example embodiment; and

FIG. 6 is a flowchart illustrating an example of operation of the tunnel slave device according to the second example embodiment.

### EXAMPLE EMBODIMENT

### First Example Embodiment

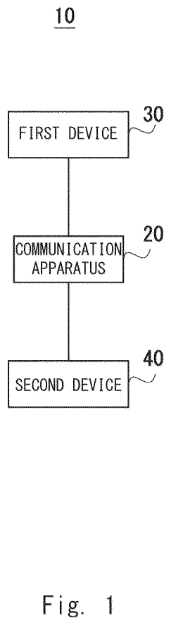

Hereinafter, example embodiments of the present disclosure will be explained with reference to the drawings. FIG. 1 is a block diagram illustrating a configuration of a communication system according to a first example embodiment. In FIG. 1, a communication system 10 includes a communication apparatus 20, a first device 30, and a second device 40.

The communication apparatus 20 communicates with the first device 30 in the same network. The communication apparatus 20 forms a tunnel network together with the opposite second device 40, and virtually communicates with the second device 40 via the tunnel network. The communication apparatus 20 communicates with the second device 40 in the same network segment. In addition, the communication apparatus 20 executes IGMP snooping. Then, the communication apparatus 20 analyzes a multicast transfer policy. Then, the communication apparatus 20 controls packet transfer for a packet to be transferred in communication between the first device 30 and the second device 40 according to the multicast transfer policy.

The outline of IGMP snooping is as follows.
Transfer data of a pertinent multicast group to a port (segment) that has received a participation packet to a multicast group (reverse transfer)
After confirming a response to member confirmation of the pertinent multicast group, update a transfer table (an aging time until time-out determination is returned to 0)
Delete the transfer table when a leave packet from a multicast group is received or when there is no response to the member confirmation for a period of time.

The first device 30 is a device having a communication function.

The second device 40 is a device having a communication function.

As described above, according to a communication system of the first example embodiment, it is possible to maintain communication quality, improve usability, and suppress a failure.

### Second Example Embodiment

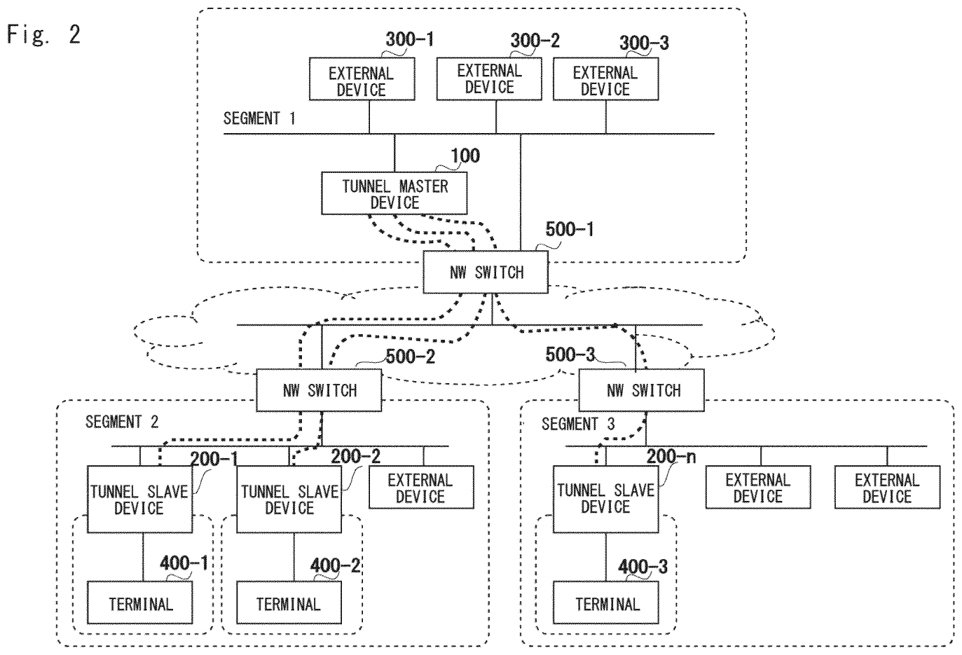

FIG. 2 is a block diagram illustrating a configuration of a communication system according to a second example embodiment. In FIG. 2, a communication system 10 includes a tunnel master device 100, tunnel slave devices 200-1 to 200-n, external devices 300-1 to 300-n, terminals 400-1 to 400-n, and NW switches 500-1 to 500-3. In FIG. 2, the same components as those in FIG. 1 are denoted by the same reference numerals, and overlapping portions of the explanation are omitted.

The communication system 10 is a one-to-N star type system that forms a remote connection (between a NW device and a terminal) tunnel or a site-to-site (between NW devices) tunnel (an apparatus side, which bundles a plurality of tunnels, is a tunnel master device, and an apparatus side, which forms a tunnel with a master device, is a slave device).

As an example, in an environment in which a plurality of NW segments separated by the NW switches 500-1 to 500-3 exist, the communication system 10 includes a tunnel master device 100 that forms a tunnel NW with a plurality of opposite devices, and tunnel slave devices 200-1 to 200-n that form a tunnel with one tunnel master device 100.

The tunnel master device 100 and the tunnel slave device 200 form a tunnel, thereby concealing an actual communication path and achieving an NW as if directly connected.

As a result, the external device 300 connected to the NW in which the tunnel master device 100 exists and the terminal 400 connected to the tunnel slave device are communicated in the same NW segment.

In the initial state, multicast except for IGMP packets is discarded for both the master device and the slave device. Only the master device executes IGMP snooping (the slave device passes through to the master device by using the in-tunnel NW). Then, the multicast transfer policy is analyzed for each tunnel (slave device).

The slave device transmits an analysis result to the slave device, and the slave device controls multicast packets other than IGMP according to the multicast transfer policy from the master device.

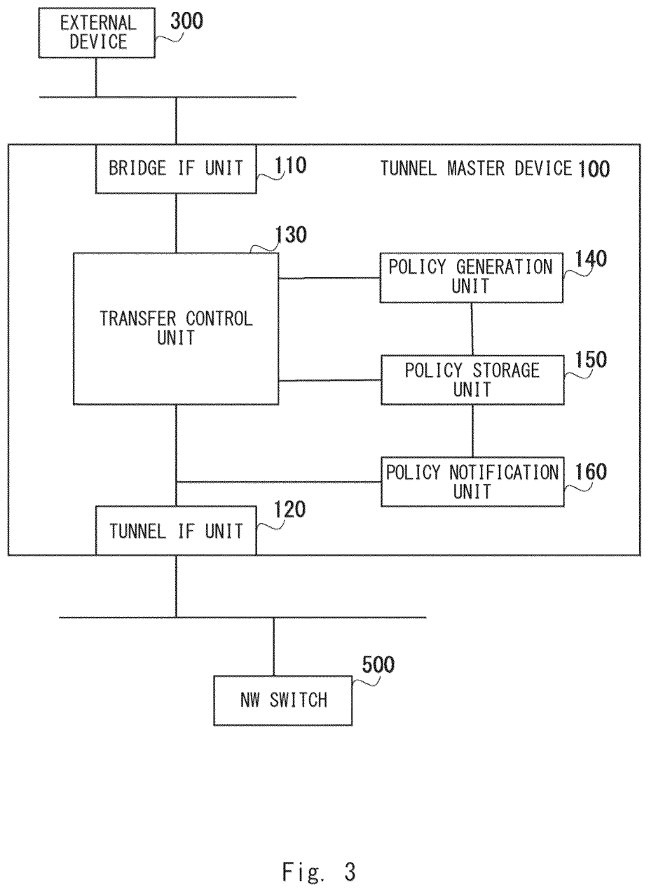

Next, a configuration of the tunnel master device 100 will be explained. FIG. 3 is a block diagram illustrating a configuration of a tunnel master device according to the second example embodiment. In FIG. 3, the tunnel master device 100 includes a bridge IF unit 110, a tunnel IF unit 120, a transfer control unit 130, a policy generation unit 140, a policy storage unit 150, and a policy notification unit 160.

The bridge IF unit 110 is an interface that communicates with the external device 300 in an installed NW segment.

The tunnel IF unit 120 is an interface that performs tunnel communication with another segment via the NW switch 500.

The transfer control unit 130 is connected to the bridge IF unit 110 and the tunnel IF unit 120. The transfer control unit 130 performs packet transfer in communication between the NW segment on the bridge IF unit 110 side and the NW segment on the tunnel side formed by the tunnel IF unit 120. The packet transfer is controlled according to a configured policy.

The policy generation unit 140 analyzes a specific packet and generates a transfer necessity policy of the multicast packet.

The policy storage unit 150 stores the policy for each tunnel path generated by the policy generation unit 140.

When the policy of the policy storage unit 150 is updated, the policy notification unit 160 notifies the tunnel slave device of an updated content via the tunnel IF unit 120.

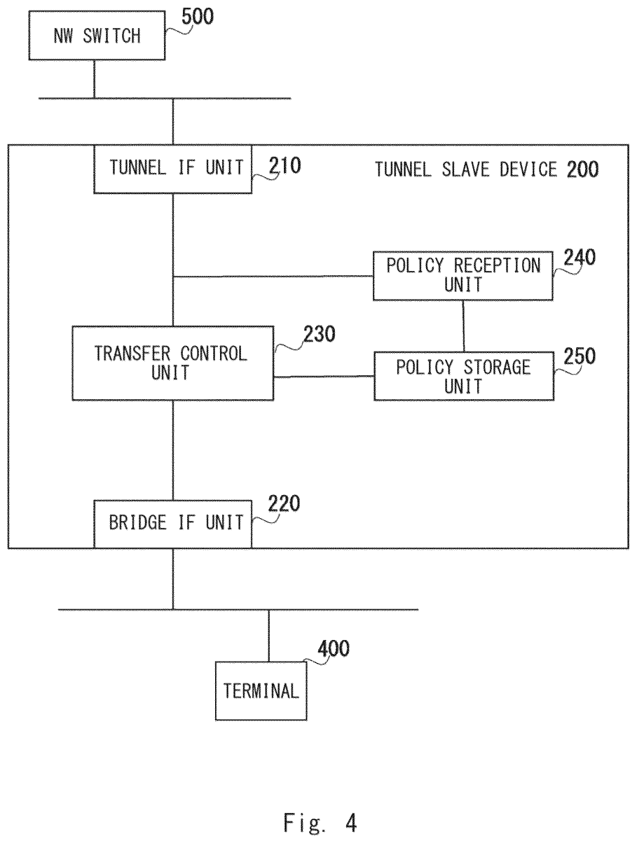

Next, a configuration of the tunnel slave device will be explained. FIG. 4 is a block diagram illustrating a configuration of a tunnel slave device according to the second example embodiment. In FIG. 4, the tunnel slave device 200 includes a tunnel IF unit 210, a bridge IF unit 220, a transfer control unit 230, a policy reception unit 240, and a policy storage unit 250.

The tunnel IF unit 210 performs tunnel communication with the tunnel master device 100.

The bridge IF unit 220 communicates with the terminal 400 in the NW segment in which the tunnel master device 100 exists as if it is directly connected to the tunnel master device 100.

The transfer control unit 230 is connected to the tunnel IF unit 210 and the bridge IF unit 220. The transfer control unit 230 performs packet transfer in communication between the NW segment on the tunnel side formed by the tunnel IF unit 210 and the NW segment on the bridge IF unit 220 side. The packet transfer is controlled according to the configured policy.

The policy reception unit 240 receives a policy generated by the tunnel master device 100 via the tunnel IF unit 210.

The policy storage unit 250 stores contents received by the policy reception unit 240.

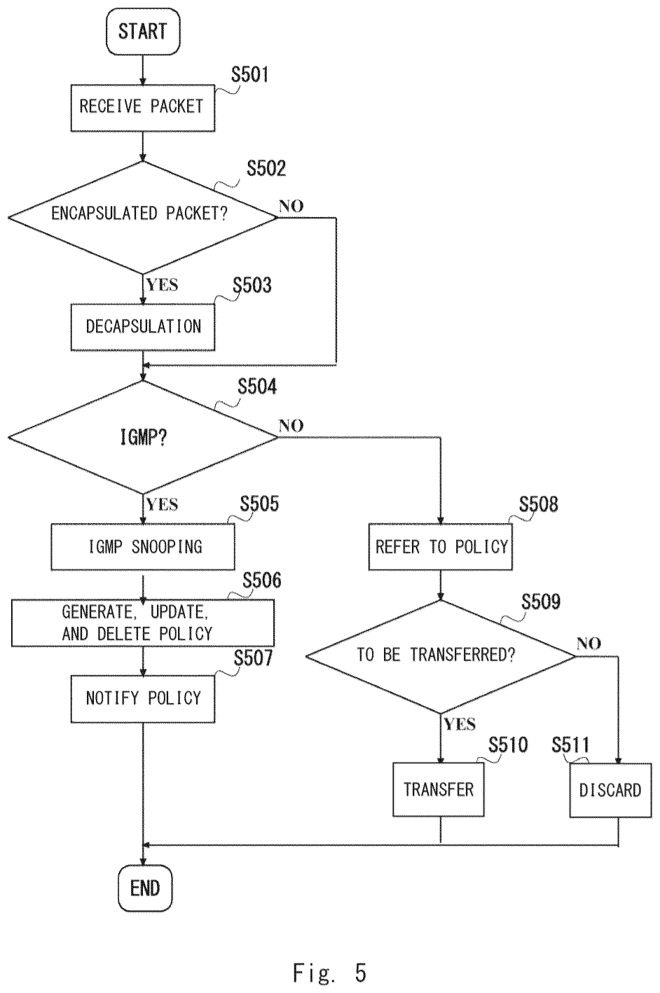

Next, an operation of the tunnel master device 100 will be explained. FIG. 5 is a flowchart illustrating an example of the operation of the tunnel master device according to the second example embodiment.

First, in step S501, the bridge IF unit 110 or the tunnel IF unit 120 receives a packet, and the processing proceeds to step S502.

In step S502, the transfer control unit 130 confirms whether the packet received from the bridge IF unit 110 or the tunnel IF unit 120 is an encapsulated packet. When the received packet is encapsulated, the processing proceeds to step S503. When the received packet is not encapsulated, the processing proceeds to step S504.

In step S503, the transfer control unit 130 decapsulates the packet. Then, the processing proceeds to step S504.

In step S504, it is determined whether the unencapsulated packet or the decapsulated packet is an IGMP packet. When the packet is an IGMP packet, the packet is transferred to the policy generation unit 140, and the processing proceeds to step S505.

In step S505, the policy generation unit 140 performs IGMP snooping, and analyzes a multicast group, a receiver address, participation, leaving, continuation confirmation, and the like. Then, the processing proceeds to step S506.

In step S506, the policy is generated, updated, or deleted in the policy storage unit 150 in such a way that pertinent multicast packet is transferred only in a direction in which the receiver exists. Then, the processing proceeds to step S507.

In step S507, the policy notification unit 160 notifies the pertinent tunnel slave device 200 of the updated content of the policy storage unit 150 via the tunnel IF unit 120. The IGMP packet that has been analyzed by the policy generation unit is returned to the transfer control unit 130 and transferred. Then, the processing ends.

When the packet is not an IGMP packet in step S504, the processing proceeds to step S508.

In step S508, the transfer control unit 130 refers to the policy stored in the policy storage unit 150. Then, the processing proceeds to step S509.

In step S509, the transfer control unit 130 determines whether the packet is to be transferred according to the policy that has been referred to. When the packet is to be transferred, the processing proceeds to step S510. When the packet is not to be transferred, the processing proceeds to step S511.

In step S510, the transfer control unit 130 transfers the packet and ends the processing. If necessary, an encapsulation step may also be included in the transfer processing according to the policy.

In step S511, the transfer control unit 130 discards the packet and ends the processing.

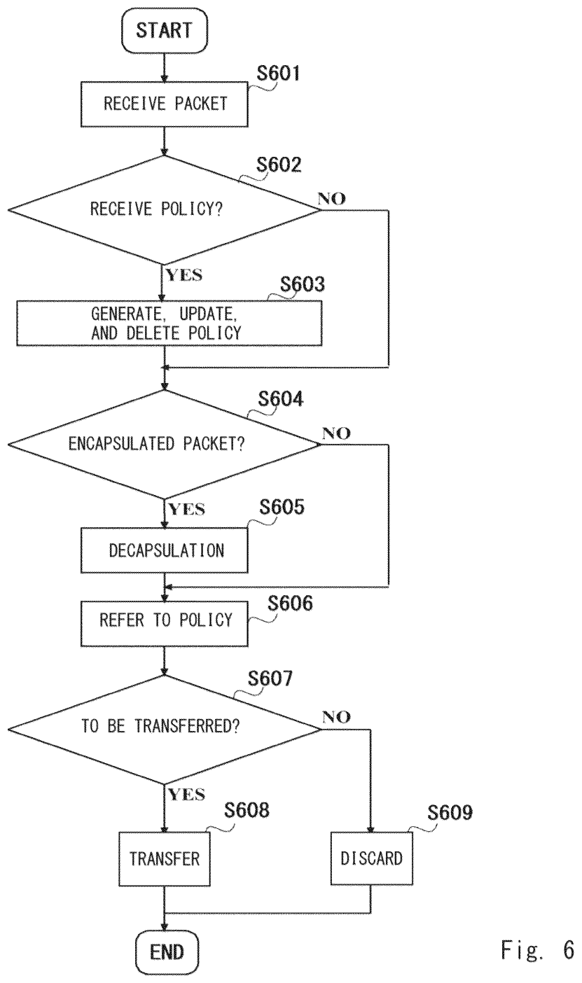

Next, an operation of the tunnel slave device 200 will be explained. FIG. 6 is a flowchart illustrating an example of operation of a tunnel slave device according to the second example embodiment.

First, in step S601, the tunnel IF unit 210 or the bridge IF unit 220 receives a packet. Then, the processing proceeds to step S602.

In step S602, the transfer control unit 230 determines whether the received packet is a policy transmitted from the tunnel master device 100. When the received packet is the policy transmitted from the tunnel master device 100, the processing proceeds to step S603. When the received packet is not the policy transmitted from the tunnel master device 100, the processing proceeds to step S604.

In step S603, the policy reception unit 240 registers, updates, and deletes the policy in the policy storage unit 250. Then, the processing proceeds to step S604.

In step S604, the transfer processing unit 230 confirms whether the packet received from the tunnel IF unit 210 or the bridge IF unit 220 is an encapsulated packet. When the packet is encapsulated, the processing proceeds to step S605. When the packet is not encapsulated, the processing proceeds to step S606.

In step S605, the transfer processing unit 230 performs decapsulation. Then, the processing proceeds to step S606.

In step S606, the transfer processing unit 230 refers to the policy stored in the policy storage unit 250. Then, the processing proceeds to step S607.

In step S607, the transfer processing unit 230 determines whether the packet is to be transferred according to the policy that has been referred to. When the packet is to be transferred, the processing proceeds to step S608. When the packet is not to be transferred, the processing proceeds to step S609.

In step S608, the transfer processing unit 230 transfers the packet and ends the processing. If necessary, an encapsulation step may also be included in the transfer processing according to the policy.

In step S609, the transfer processing unit 230 discards the packet and ends the processing.

As described above, according to the communication system of the second example embodiment, by filtering the multicast that does not need to be transferred, communication within the tunnel NW or to the NW behind the opposite device can be suppressed by using the devices at both ends of the tunnel, and therefore, communication quality can be maintained, usability can be improved, and a failure can be suppressed.

Further, according to the communication system of the second example embodiment, since it is possible to automatically analyze whether transfer is necessary, it is possible not only to eliminate the need for a precast multicast routing design, but also to flexibly cope with changes and additions to the system, thereby suppressing costs.

Further, according to the communication system of the second example embodiment, by placing an apparatus in a case where there is a difference in the NW-scale behind the apparatus on the master device side and the slave device side and making the mounting and the processing on the slave device side lighter, it is possible to reduce the size and power saving of a slave device side apparatus, and it is possible to expand a utilization destination of Internet of things (IoT) and the like.

The present disclosure is not limited to the above-described example embodiments, and can be appropriately modified without departing from the scope of the present disclosure. For example, a configuration may be adopted in which a wireless section is included in a tunnel path. Since the bandwidth of wireless routes is limited, an effect of filtering multicast communication is greater. Further, in the above-described example embodiments, an example including an NW switch is explained as an example, but the present disclosure can be applied to a flat NW environment in which no NW switch (router) exists.

In addition to IGMP snooping, a policy for transferring a part of multicast addresses may be registered in advance. As a result, a processing load and a processing time (communication delay) can be reduced.

Further, a measurement means for measuring an amount of multicast communication may be provided, and a transfer means may be executed only when the amount of multicast communication is equal to or greater than a fixed amount. As a result, the processing load and the processing time (communication delay) can be reduced.

In addition, the policy notification unit 160 and the policy reception unit 240 may perform arrival confirmation and retransmission control of the reception. As a result, it is possible to prevent policy mismatch due to packet loss or the like.

In addition, the policy storage unit may manage the policy for each tunnel (tunnel slave device) and synchronize the policy as a whole instead of notifying only the policies of addition, update, and deletion. As a result, it is possible to prevent policy mismatch due to packet loss or the like.

The communication program for operating the communication system includes an instruction group (or software codes) for causing the computer to perform one or more of the functions explained in the example embodiments when read into the computer. The program may be stored in a non-transitory computer-readable medium or a tangible storage medium. By way of example, and not limitation, computer-readable media or tangible storage media include random-access memory (RAM), read-only memory (ROM), flash memory, solid-state drive (SSD) or other memory techniques, CD-ROM, digital versatile disc (DVD), Blu-ray (registered trademark) disk or other optical disk storage, magnetic cassette, magnetic tape, and magnetic disk storage or other magnetic storage devices. The program may be transmitted on a transitory computer readable medium or a communication medium. By way of example, and not limitation, transitory computer-readable media or communication media include electrical, optical, acoustic, or other forms of propagated signals.

This application claims priority based on Japanese Patent Application No. 2022-035833 filed on Mar. 9, 2022, the disclosure of which is incorporated herein in its entirety.

### REFERENCE SIGNS LIST

10 COMMUNICATION SYSTEM
20 COMMUNICATION APPARATUS
30 FIRST DEVICE
40 SECOND DEVICE
100 TUNNEL MASTER DEVICE
110, 220 BRIDGE IF UNIT
120, 210 TUNNEL IF UNIT
130, 230 TRANSFER CONTROL UNIT
140 POLICY GENERATION UNIT
150 POLICY STORAGE UNIT
160 POLICY NOTIFICATION UNIT
200 TUNNEL SLAVE DEVICE
240 POLICY RECEPTION UNIT
250 POLICY STORAGE UNIT
300 EXTERNAL DEVICE
400 TERMINAL
500 SWITCH

What is claimed is:

1. A communication system comprising:
at least one first device configured to have a communication function;
at least one second device configured to have a communication function; and
a communication apparatus configured to
communicate with the first device within the same network,
form a tunnel network together with the opposite second device, and virtually communicate with the second device in the same network segment via the tunnel network,
execute IGMP snooping, and analyze a multicast transfer policy, and
control packet transfer according to the multicast transfer policy for a packet to be transferred in communication between the first device and the second device.

2. The communication system according to claim 1, wherein the communication apparatus includes
at least one memory storing instructions; and
at least one processor configured to execute the instructions to do motion determination process, wherein the motion determination process includes:
communicating with a device within the same network,
forming a tunnel network together with an opposite device and virtually enabling communication with the opposite device in the same network segment via the tunnel network,
storing a plurality of communication policies between the same network and the same network segment, and enabling reference to the communication policy, and
referring to a communication policy stored in the policy storage portion, and performing transfer control of a packet received by the communication portion or the tunnel communication portion according to the communication policy.

3. The communication system according to claim 2, wherein the transfer control portion discards multicast except for an IGMP packet in an initial state.

4. The communication system according to claim 2, wherein the tunnel communication portion passes through a wireless communication section in a tunnel communication path.

5. The communication system according to claim 2, wherein
the communication apparatus includes
policy generation portion, and
measurement portion for measuring an amount of multicast packets from the received packets, and
the transfer control portion transfers the multicast packet to the policy generation portion only when an amount of multicast packets acquired by the measurement portion is equal to or greater than a fixed value.

6. The communication system according to claim 2, wherein the tunnel communication portion transmits the communication policy to the second device, and confirms that the communication policy has reached the second device.

7. The communication system according to claim 2, wherein one of the first device and the second device includes
at least one memory storing instructions; and
at least one processor configured to execute the instructions to do motion determination process, wherein the motion determination process includes:
storage means for storing a communication policy, and
synchronizing a content stored in the policy storage portion.

8. A communication apparatus comprising:
at least one memory storing instructions; and
at least one processor configured to execute the instructions to do motion determination process, wherein the motion determination process includes:
communicating with a device within the same network;
forming a tunnel network together with an opposite device, and virtually enabling communication with the opposite device in the same network segment via the tunnel network;
storing a plurality of communication policies between the same network and the same network segment, and enabling reference to the communication policy; and
referring to a communication policy stored in the policy storage portion, and performing transfer control of a packet received by the communication portion or the tunnel communication portion according to the communication policy.

9. A communication method, comprising:
communicating with at least one first device within the same network;
forming a tunnel network together with at least one opposite second device, and virtually communicating with the second device in the same network segment via the tunnel network;
executing IGMP snooping, and analyzing a multicast transfer policy; and
controlling packet transfer according to the multicast transfer policy for a packet to be transferred in communication between the first device and the second device.

10. (canceled)
